(19) United States
(12) Patent Application Publication
(10) Pub. No.: US 2009/0140078 A1
(43) Pub. Date: Jun. 4, 2009

(54) FUEL INJECTOR WITH MECHANIC DAMPING

(76) Inventors: Franco Ciampolini, Bologna (IT); Andrea Ricci, Casalecchio Di Reno (IT); Massimo Armaroli, Monte San Pietro (IT); Luca Gusmerini, Valmadonna (IT); Bruno Monteverde, Bologna (IT)

Correspondence Address: GOTTLIEB RACKMAN & REISMAN PC, 270 MADISON AVENUE, 8TH FLOOR, NEW YORK, NY, 10016-0601, US

(21) Appl. No.: 12/323,591

(22) Filed: Nov. 26, 2008

(30) Foreign Application Priority Data
Nov. 28, 2007 (EP) 07425755.1

(51) Int. Cl. F02M 61/00

(52) U.S. Cl. 239/533.12

(57) ABSTRACT

A fuel injector provided with: an injection valve comprising an injection nozzle; a mobile needle for adjusting the flow of fuel through the injection valve and ending in a shutting head which engages a valve seat of the injection valve; an actuator for displacing the needle between a closing position and an opening position of the injection valve; a catch element which constitutes an upper end stroke of the needle and defines the opening position; and a mechanical damping device which is interposed between the needle and the catch element and which is adapted to generate on the needle an elastic force which opposes to the movement of the needle towards the opening position when the needle is in proximity of the catch element.

### TECHNICAL FIELD

The present invention relates to a fuel injector.

The present invention is advantageously applied to an electromagnetic injector, to which explicit reference will be made in the following description without therefore loosing in generality.

### BACKGROUND ART

A fuel injector comprises a cylindrical tubular accommodation body having a central feeding channel, which serves as fuel pipe and ends with an injection nozzle adjusted by an injection valve controlled by an electromagnetic actuator. The injection valve is provided with a needle, which is rigidly connected to a mobile keeper of the electromagnetic actuator to be displaced by the action of the electromagnetic actuator between a closing position and an opening position of the injection nozzle against the bias of a closing spring which tends to maintain the needle in the closing position. The needle ends with a shutting head, which in the closing position is pushed by the closing spring against the valve seat of the injection valve to prevent the fuel from leaking.

The closing position of the needle is defined by the contact of the shutting head against the valve seat of the injection valve, i.e. the contact of the shutting head against the valve seat of the injection valve constitutes a lower end stroke of the needle. The opening position of the needle is defined by the contact between a portion of the needle and a catch element which constitutes an upper end stroke of the needle.

When the injector is driven to inject the fuel, the needle is displaced from the closing position to the opening position thus performing an opening stroke; at the end of the opening stroke, the needle collides into the catch element which constitutes the upper end stroke; following this collision, the needle rebounds and thus collides into the catch element again at slower speed rebounding again and so on. In other words, a damped oscillatory motion is established which after a few cycles leads the needle to arrange immobile in contact with the catch element which constitutes the upper end stroke.

The above-described rebound of the needle against the catch element which constitutes the upper end stroke does not essentially cause any negative consequence when the injector is maintained open for a relatively long injection time (i.e. for an injection time longer than the time needed for the oscillatory behaviour triggered by the rebound to be exhausted), because when the needle is returned to the closing position, the oscillatory behaviour triggered by the rebound is by then exhausted. Instead, the above-described rebounding phenomenon of the needle against the catch element which constitutes the upper end stroke introduces a high uncertainty in the amount of injected fuel when the injector is maintained open for a short injection time (i.e. for an injection time shorter than the time needed for the oscillatory behaviour triggered by the rebound to be exhausted), because when the needle is returned to the closing position the oscillatory behaviour triggered by the rebound has not yet been exhausted.

During the oscillatory behaviour triggered by the rebound, the needle may have either a positive speed (i.e. may be displaced towards the opening position thus moving away from the closing position) of variable value or may have a negative speed (i.e. may be displaced towards the closing position thus moving away from the opening position) of variable value. When the closing command is imparted during the oscillatory behaviour triggered by the rebound, the needle may have either a positive speed which opposes to the closing or a negative speed which promotes the closing in an uncertain manner (i.e. not predictable a priori); in both cases, the closing times are considerably different and thus the opening time of the needle being equal, the amount of fuel which is injected may randomly vary in a manner not predictable a priori.

It is worth emphasizing that the oscillatory behaviour triggered by the rebound is affected by various factors which are difficult to predict and however displays a certain randomness; consequently, the oscillatory behaviour triggered by the rebound is essentially uncertain and thus can neither be accurately predicted a priori nor compensated a posteriori, e.g. by compensating the injection times.

As previously described, by effect of the oscillatory behaviour triggered by the rebound, for short injection times, the amount of fuel which is injected may randomly vary in a manner not predictable a priori; consequently, for short injection times, the injection time/injected fuel amount feature displays a pronounced lack of linearity and a high randomness (i.e. lack of repeatability). Such lack of linearity and of repeatability for short injection times is particularly harmful in modern internal combustion engines, in which a punctual and very accurate torque control is required in order to effectively perform vehicle traction and stability controls.

### DISCLOSURE OF INVENTION

It is the object of the present invention to make a fuel injector which is free from the above-described drawbacks and is specifically easy and cost-effective to manufacture.

According to the present invention, a fuel injector is made as set forth in the attached claims.

### BRIEF DESCRIPTION OF THE DRAWINGS

The present invention will now be described with reference to the accompanying drawings, which illustrate some non-limitative embodiments thereof, in which:

FIG. 1 is a diagrammatic, side section view with parts removed for clarity of a fuel injector made according to the present invention;

FIG. 2 shows a detail of the fuel injector in FIG. 1 on an enlarged scale; and

FIG. 3 is a perspective view of an elastic body of the fuel injector in FIG. 1;

FIG. 4 is a plan view of the elastic body in FIG. 3;

FIG. 5 is a side view of the elastic body in FIG. 3; and

FIG. 6 is a plan view of a foil of the elastic body in FIG. 3.

### BEST MODE FOR CARRYING OUT THE INVENTION

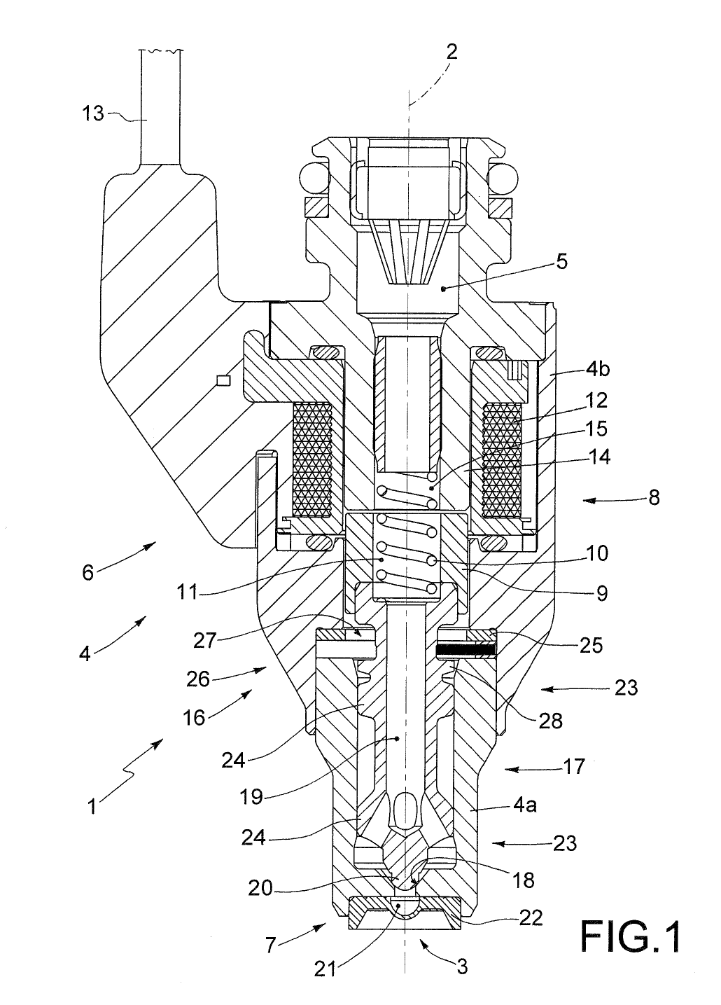

In FIG. 1, numeral 1 indicates as a whole a fuel injector, which essentially has a cylindrical symmetry about a longitudinal axis 2 and which is controlled to inject fuel from an injection nozzle 3. The injector 1 comprises a supporting body 4, which has a cylindrical tubular shape of variable section along the longitudinal axis 2 and has a feeding channel 5 extending along its entire length to feed the pressurized fuel to the injection nozzle 3. The supporting body 4 accommodates an electromagnetic actuator 6 at an upper portion thereof and an injection valve 7 which delimits at its lower part the feeding channel 5 at a lower portion thereof; in use, the injection valve 7 is actuated by the electromagnetic actuator 6 to adjust the fuel flow through the injection nozzle 3, which is obtained in the injection valve 7 itself.

Preferably, the supporting body 4 consists of an upper portion 4b accommodating the electromagnetic actuator 6 and a lower portion 4a accommodating the injection valve 7 which are joined together by welding.

The electromagnetic actuator 6 comprises an electromagnet 8, which is accommodated in a fixed position within the supporting body 4 and when energized displaces a ferromagnetic material mobile keeper 9 along axis 2 from a closing position to an opening position of the injection valve 7 against the bias of a closing spring 10 which tends to maintain the mobile keeper 9 in the closing position of the injection valve 7. The mobile keeper 9 has a central axial through hole 11 (i.e. parallel to the longitudinal axis 2) to allow the flow of fuel towards the injection nozzle 3. The electromagnet 8 further comprises a coil 12 which is electrically supplied by an electronic control unit (not shown) by means of an electric wire 13 and a fixed magnetic yoke 14, which is accommodated inside the supporting body 4 and has a central axial through hole 15 (i.e. parallel to the longitudinal axis 2) for allowing the fuel flow towards the injection nozzle 3.

The mobile keeper 9 is a part of a mobile element 16, which further comprises a shutter or needle 17, having an upper portion integral with the mobile keeper 9 and a lower portion cooperating with a valve seat 18 of the injection valve 7 to adjust the fuel flow through the injection nozzle 3 in a known manner. The needle 17 is crossed by a feeding hole 19, which has an upper axial inlet and four lower inclined outlets (only three of which are shown in FIG. 1); the fuel passing through the central hole 11 of the mobile keeper 9 enters into the feeding hole 19 of the needle 17 through the upper axial inlet and then exits from the feeding hole 19 of the needle 17 through the lower outlets.

The needle 17 ends with a shutting head 20, which is adapted to tightly rest against the valve seat 18, displaying a shape which negatively reproduces the shape of shutting head 20 itself. Downstream of the valve seat 18 there is obtained a semi-spherical injection chamber 21, which is crossed by at least one through hole which defines the injection nozzle 3 and is formed by a plate 22 which is welded to the supporting body 4.

The mobile keeper 9 of the electromagnet 8 is ring-shaped and has a smaller diameter than the internal diameter of the corresponding portion of the feeding channel 5 of the supporting body 4, and consequently the mobile keeper 9 cannot even serve as upper guide of the needle 17. According to the embodiment shown in FIG. 1, the needle 17 comprises a pair of guiding elements 23, which are reciprocally and axially spaced and serve as upper and lower guides of the needle 17. Each guiding element 23 has bulges 24 (only two of which are shown in FIG. 1) having an external diameter equal to the internal diameter of the feeding channel 5; typically, each guiding element 23 has three or four bulges 24 symmetrically distributed as a triangle or cross. Obviously, the fuel may flow towards the injection nozzle 3 passing through the void between the bulges 24.

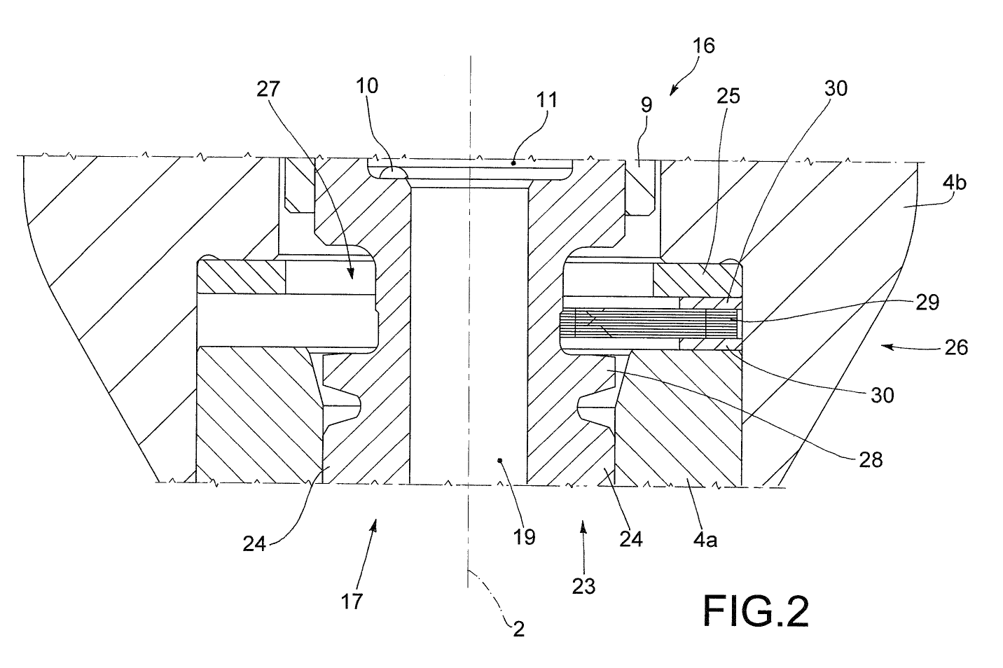

As shown in FIG. 2, there is a ring-shaped catch element 25 which is arranged inside the feeding channel 5, constitutes an upper end stroke of the needle 17 and defines the opening position; in other words, the opening movement of the needle 17 is stopped in the opening position by effect of the action of the catch element 25, as will be described in detail below. The lower end stroke of the needle 17 which defines the closing position is the valve seat 18 against which the closing movement of the needle 17 stops.

Furthermore, the injector 1 comprises a mechanical damping device 26, which is adapted to generate on the needle 17 an elastic force which opposes to the movement of the needle 17 towards the opening position when the needle 17 is in proximity of the catch element 25. The mechanical damping device 26 comprises an elastic leaf spring body 27, which is interposed between the catch element 25 and the needle 17 so that in its opening movement the needle 17 does not violently collide into the catch element 25 which is a rigid body, but is progressively slowed down until it stops by effect of an elastic force which opposes to the movement of the needle 17 towards the opening position, and progressively increases (i.e. the nearer the needle 17 gets the catch element 25, the greater this elastic force is) until it completely balances the force exerted on the needle 17 by the actuator 6. The elastic force which acts on the needle is generated by the elastic body 27 which is progressively deformed under the bias of the needle 17. It is worth underlining that the elastic force generated by the deformation of the elastic body 27 must balance both the force exerted on the needle 17 by the actuator 6, and the inertia (i.e. deriving from the kinetic energy) of the needle 17 by effect of the movement towards the opening position.

According to the preferred embodiment shown in FIG. 2, the needle 17 comprises a plate 28, which is integral with the needle 17 and has an external crown facing the elastic body 27 so as to collide into the elastic body 27 during the opening movement.

The elastic body 27 is ring-shaped and may be either closed (i.e. seamless), if the elastic body 27 is inserted axially about the needle 17, or open (i.e. with an opening) if the elastic body 27 is mounted transversally about the needle 17 (in this case, the elastic body 27 is temporarily deformed to spread the opening and allow the passage of the needle 17 through the spread opening).

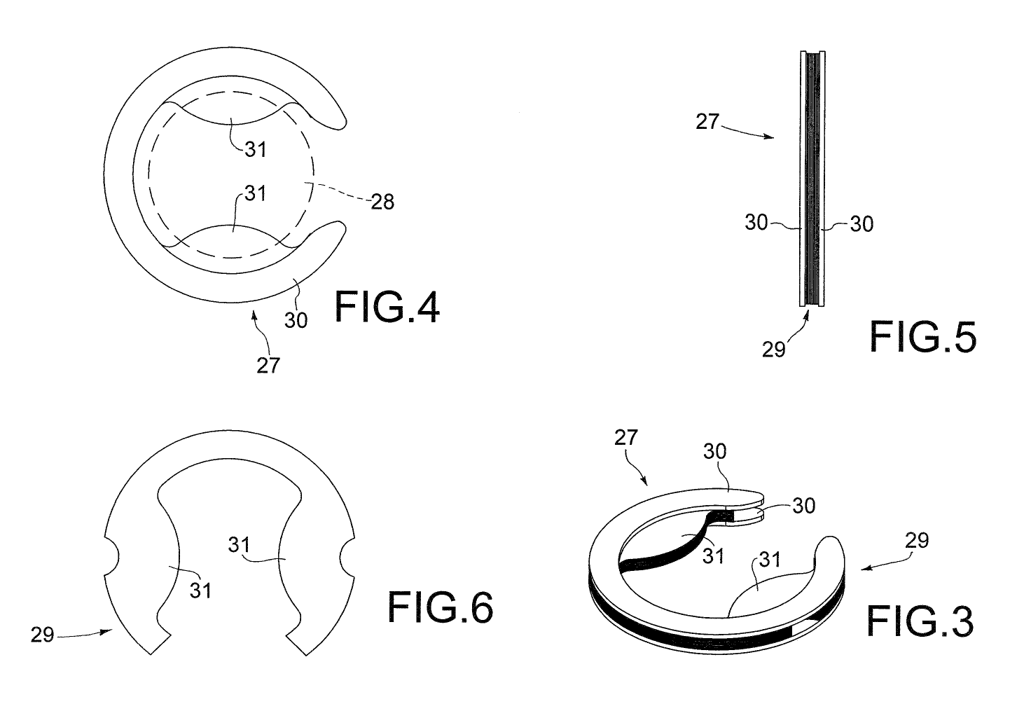

Preferably, the elastic body 27 consists of a plurality of thin foils 29 sandwiched onto each other and enclosed between two thicker retaining rings 30. As shown in FIGS. 3-6, the foils 29 are ring-shaped and have inward protruding flaps 31 to interfere with the plate 28 integral with the needle 17; on the contrary, the two retaining rings 30 are ring-shaped and are free from flaps so as not to interfere with the plate 28 integral with the needle 17. In this manner, the retaining rings 30 have the sole function of sandwiching and mechanically stabilizing the foil pack 29 but do not serve to generate any elastic force exerted on the needle 17; the elastic force exerted on the needle 17 is solely generated by the foils 29 which are elastically deformed by effect of the interaction with the needle 17. Generally, a number of foils 29 from 5 to 30 is included and each foil 29 has a thickness in the range between 30 and 80 μm. In order to increase the flexibility of the foils 29, the foils 29 themselves could have radial slots.

According to the embodiment shown in the accompanying figures, in the closing position the needle 17 (specifically the plate 28 integral with the needle 17) is detached from the elastic body 27; therefore, the needle 17 (specifically, the plate 28 integral with the needle 17) comes into contact with the elastic body 27 only during the final step of the opening movement. According to a different embodiment (not shown), in the closing position the needle 17 (specifically the plate 28 integral with the needle 17) rests on the elastic body 27; therefore the needle 17 (specifically the plate 28 integral with the needle 17) is always in contact with the elastic body 27. In the latter case, in the closing position, the elastic body 27 could also be pre-loaded, i.e. could generate a non-zero elastic force on the needle (17).

The pliability curve of the elastic body 27 could be linear (i.e. the linear force generated by the elastic body 27 is directly proportional to the axial deformation of the elastic body 27 itself). However, according to a preferred embodiment, the pliability curve of the elastic body 27 is non-linear and increases more than proportionally as the axial deformation of the elastic body 27 increases; specifically, the pliability curve of the elastic body 27 increases in a parabolic quadratic or cubic manner (i.e. the elastic force generated by the elastic body 27 is proportional to either the square or cube of the axial deformation of the elastic body 27 itself). In this manner, the needle 17 may be displaced more rapidly towards the opening position and be slowed down in a more clean manner only in proximity of the opening position (indicatively during the last third of the opening stroke).

Preferably, an axial dimension (i.e. along the longitudinal axis 2) of the gap existing between the mobile keeper 9 and the fixed magnetic yoke 14 is such so as to be always higher than the length of the stroke of the needle 17 limited by the catch element 25 (with the interposition of the elastic body 27) to guarantee that the length of the stroke is determined by the catch element 25 and not by the abutment of the mobile keeper 9 against the fixed magnetic yoke 14. From the above, it is apparent that the gap existing between the mobile keeper 9 and the fixed magnetic yoke 14 is never cancelled (therefore avoiding magnetic sticking phenomena between the mobile keeper 9 and the magnetic yoke 14), because the mobile keeper 9 never comes into contact with the fixed magnetic yoke 14; obviously, during the step of designing the electromagnet 8, the influence of the gap which has a larger dimension than that of a traditional electromagnetic injector must be taken into account.

In use, when the electromagnet 8 is not energized, the mobile keeper 9 is not attracted by the fixed magnetic yoke 14 and the elastic force of the closing spring 10 pushes the mobile keeper 9 along with the needle 17 downwards so as to keep the needle 17 in the closing position; in this situation, the shutting head 20 of the needle 17 is pressed against the valve seat 18 of the injection valve 7, preventing the fuel from leaking. When the electromagnet 8 is energized, the mobile keeper 9 is magnetically attracted by the fixed magnetic yoke 14 against the elastic force of the closing spring 10 and the mobile keeper 9 along with the needle 17 is displaced upwards until the movement of the needle 17 is stopped in the opening position by the combined action of the catch element 26 and of the mechanical damping device 26; in this situation, the mobile keeper 9 is separated from the fixed magnetic yoke 14, the shutting head 20 of the needle 17 is lifted with respect to the valve seat 18 of the injection valve 7, and the pressurized fuel may flow through the injection nozzle 3.

In virtue of the action of the mechanical damping device 26, the needle 17 at the end of the opening stroke does not violently collide into the catch element 25, but gradually and smoothly stops by effect of the increasing elastic force generated by the deformation of the elastic body 27; in this manner, the needle 17 is not subjected to any type of rebound or, however, is subjected to a very small and thus essentially negligible rebound. Consequently, no oscillatory behaviour is triggered by a rebound and also for short injection times the amount of fuel which is injected is directly proportional to the injection time (i.e. to the opening time of the injector 1) without random variations which are not predictable a priori. Therefore, also for short injection times, the injection time/injected fuel amount feature displays a high linearity and a high repeatability.

Furthermore, the absence of a significant collision between the needle 17 (specifically between the plate 28 integral with the needle 17) and the catch element 25 reduces the mechanical wear of the two components themselves and does not require the external surfaces of such components to be treated to increase their mechanical resistance. Consequently, the above-described injector 1 has a particularly long working life, has shorter settling times (i.e. run-in times for stabilizing its features) and is also cost-effective to manufacture.

1. A fuel injector (1) comprising:
an injection valve (7) comprising an injection nozzle (3);
a mobile needle (17) for adjusting the fuel flow through the injection valve (7) and ending in a shutting head (20) which engages a valve seat (18) of the injection valve (7);
an actuator (6) for displacing the needle (17) between a closing position and an opening position of the injection valve (7); and
a catch element (25) which constitutes an upper end stroke of the needle (17) and defines the opening position;
the injector (1) is characterized in that it comprises a mechanical damping device (26) which is interposed between the needle (17) and the catch element (25) and which is adapted to generate on the needle (17) an elastic force which opposes to the movement of the needle (17) towards the opening position when the needle (17) is in proximity of the catch element (25).

2. An injector (1) according to claim 1, wherein the mechanical damping device (26) comprises an elastic leaf spring body (27), which is arranged between the catch element (25) and the needle (17) and which is progressively deformed under the bias of the needle (17).

3. An injector (1) according to claim 2, wherein the needle (17) comprises a plate (28), which is integral with the needle (17) and which has an external crown facing the elastic body (27) so as to collide into the elastic body (27) during the opening movement.

4. An injector (1) according to claim 2, wherein the elastic body (27) is ring-shaped.

5. An injector (1) according to claim 2, wherein the elastic body (27) comprises a plurality of thin foils (29) sandwiched onto each other.

6. An injector (1) according to claim 5, wherein the elastic body (27) comprises two thicker retaining rings (30) which sandwich the two thin foils (29) together.

7. An injector (1) according to claim 6, wherein the foils (29) are ring-shaped and have inward protruding flaps (31) to interfere with a plate (28) integral with the needle (17); the two retaining rings (30) are ring-shaped and are free from flaps so as not to interfere with the plate (28) integral with the needle (17).

8. An injector (1) according to claim 5, wherein a number of foils (29) from 5 to 30 is included.

9. An injector (1) according to claim 5, wherein each foil (29) has a thickness between 30 and 80 μm.

10. An injector (1) according to claim 5, wherein the foils (29) have radial slots.

11. An injector (1) according to claim 2, wherein in the closing position the needle (17) is detached from the elastic body (27).

12. An injector (1) according to claim 2, wherein in the closing position the needle (17) rests on the elastic body (27).

13. An injector (1) according to claim 12, wherein in the closing position the elastic body (27) is pre-loaded and generates a non-zero elastic force on the needle (17).

14. An injector (1) according to claim 2, wherein the pliability curve of the elastic body (27) is linear.

15. An injector (1) according to claim 2, wherein the pliability curve of the elastic body (27) is non-linear and increases more than proportionally as the axial deformation of the elastic body (27) increases.

16. An injector (1) according to claim 15, wherein the pliability curve of the elastic body (27) increases parabolically according to the axial deformation of the elastic body (27) itself.

17. An injector (1) according to claim 1, wherein the actuator (6) comprises a spring (10) which pushes the needle (17) towards the closing position.

18. An injector (1) according to claim 17, wherein the actuator (6) is of the electromagnetic type and comprises at least one coil (12), at least one fixed magnetic yoke (14), and at least one mobile keeper (9), which is magnetically attracted by the fixed magnetic yoke (14) against the bias of the spring (10) and is mechanically connected to the needle (17).

19. An injector (1) according to claim 18, wherein an axial dimension of the gap existing between the mobile keeper (9) and the fixed magnetic yoke (14) is always larger than the length of the stroke of the needle (17) limited by the catch element (25) in order to guarantee that the length of the stroke is determined by the catch element (25) and not by the abutment of the mobile keeper (9) against the fixed magnetic yoke (14).

20. An injector (1) according to claim 1 and comprising a supporting body (4), which has a variable-section tubular cylindrical shape and has a feeding channel (5) delimited at its lower part by the injection valve (7); the needle (17) is arranged inside the feeding channel (5), has an external diameter smaller than the internal diameter of the feeding channel (5) and comprises a pair of reciprocally spaced guiding elements (23) each of which has bulges (24) having an external diameter equal to the internal diameter of the feeding channel (5).

21. An injector (1) according to claim 1, wherein the needle (17) is crossed by a feeding hole (19), which has an upper inlet and a plurality of lower outlets.

22. An injector (1) according to claim 21, wherein the feeding hole (19) has an upper axial inlet and a plurality of lower inclined outlets.
